(19) United States
(12) Patent Application Publication
(10) Pub. No.: US 2009/0080613 A1
(43) Pub. Date: Mar. 26, 2009

(54) Arrangement for the taking of X-ray scatter images and/or gamma ray scatter images

(76) Inventor: Peter KRUGER, Dresden (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/236,637

(22) Filed: Sep. 24, 2008

(30) Foreign Application Priority Data
Sep. 25, 2007 (DE) 10 2007 045 798.9

(51) Int. Cl. G01N 23/201

(52) U.S. Cl. 378/87

(57) ABSTRACT

The present invention relates to an arrangement for the taking of X-ray powder diffraction images and/or gamma ray powder diffraction images, comprising a plurality of X-ray sensitive and/or gamma ray sensitive individual detectors (1a, 1b, . . . ) and the same plurality of collimator diaphragms (2a, 2b, . . . ) made for the collimation of X-rays and/or gamma rays, with a respective one of the collimator diaphragms being associated with each individual detector, and with each of the detection units (3a, 3b, . . . ) formed in this manner from an individual detector and the collimator diaphragm associated with it being arranged such that all the detection units are aligned to one and the same common center (Z).

The present invention relates to an arrangement for the taking of X-ray scatter images and/or gamma ray scatter images. The present invention furthermore relates to a corresponding method for the taking of X-ray scatter images and/or gamma ray scatter images.

Various objects cannot be inspected by means of conventional X-ray exposure methods due to their size (for example large aircraft parts) or due to their location (for example cellar walls of a static, building). However, there is also a need with such objects to characterize these objects three-dimensionally at least close to the surface in order, for example, to carry out material inspections, in particular, for example, to locate cracks, inclusions or other structural defects.

The so-called “ComScan” method is known from the prior art for this purpose. In this method, a punctiform X-ray beam (a so-called pencil beam) is directed to an object to be inspected by means of an X-ray tube and a collimation device disposed after said X-ray tube. The scattered radiation is detected with depth resolution using a line detector which is located after a further collimation device (pinhole diaphragm). A three-dimensional image of the object is taken by a two-dimensional scanning of the object in this process. The detected radiation is primarily the Compton scattered radiation which is generated in the object by the irradiation of the object by means of the X-ray tube (this physical effect is well known to the skilled person).

However, in the ComScan process, due to the collimation on both sides (both on the radiation inlet side and on the radiation outlet side), only a fraction of the X-rays produced by the X-ray tube is used. This has the result that the method is very expensive with respect to its energy outlay and with respect to its time requirements.

Starting from this method known from the prior art, it is the object of the present invention to provide an arrangement for the taking of X-ray scatter images and/or gamma ray scatter images with which large objects which cannot be X-rayed conventionally can also be inspected reliably, simply and fast with respect to their structure. It is furthermore the object of the present invention to provide a corresponding method.

The aforesaid object is solved by the arrangement in accordance with claim 1 and by the method in accordance with claim 15. Advantageous embodiments in accordance with the invention can be seen from the respective dependent claims. Uses in accordance with the invention are described in claim 17.

The arrangement in accordance with the invention and the method in accordance with the invention are based on the principle that the collimation disposed at the inlet side (i.e. between the X-ray tube and the irradiated object) is dispensed with and that the object is simultaneously scanned using a plurality of detection units. Such a detection unit in this respect includes, as will be explained in more detail in the following, an X-ray sensitive detector as well as a collimator diaphragm disposed before it (i.e. located between the irradiated object and the associated detector). The detectors of the detection units used are preferably flat-screen detectors (for example digital flat-screen detectors) well known to the skilled person. The collimator diaphragms used are preferably simple pinhole diaphragms. Pinhole diaphragms made from a material such as lead highly absorbent for X-ray radiation (or also gamma radiation, see the following) can preferably be used which have a sufficient thickness so that radiation (e.g. X-ray radiation scattered by the object) only passes through the hole of the pinhole diaphragm and images the object in the manner of a pinhole camera on the associated flat-screen detector arranged behind the collimator diaphragm viewed from the object. The size of the hole in the pinhole diaphragm or in the collimator diaphragm (or the diameter of the hole) is selected in this respect in dependence on the distance of the object from the detector, on the size of the object to be irradiated and on the size of the detector used and/or on its pixel size. Pinhole diaphragms having hole diameters in the range of 0.05 mm to 2 mm are used, for example.

For the simultaneous scanning of the object, a plurality of such detector units are now used which each comprise a detector element and an associated pinhole diaphragm, preferably arranged on a circle such that each detection unit is directed to a common center in which the object to be imaged or irradiated is arranged. This will be described more closely in detail in the following.

Instead of irradiating the object by means of X-rays from an X-ray tube, it is, however, also possible to carry out the imaging using gamma rays. For this purpose, for example, radioactive markers (gamma rays) can be introduced into the object so that the object is irradiated in its interior outwardly from its interior due to the radioactive decay of the radioactive markers. The radiation then generated in the interior of the object is detected in the same manner as in the case of the irradiation by means of the X-ray tube.

The principle in accordance with the invention thus exploits substantially more radiation of an X-ray tube due to a collimation on the radiation inlet side being dispensed with and thus makes is possible, in conjunction with the scanning of the object, by the simultaneous use of a plurality of detection units or detectors and collimator diaphragms arranged around the object that the object is irradiated areally and can be scanned fast and easily. The scattered radiation now coming from the total volume is thus taken synchronously with the help of a plurality of detection units (preferably arranged on a circle) in the form of “pinhole cameras” which are oriented toward a common center.

The individual emission images or scattered radiation images detected by the individual detection units or their detectors can then be reverse calculated to form a volume or layer images of the volume (due to the arrangement of the individual detection units around the object to be imaged, in particular due to the arrangement on a circle) in a comparable manner as in computer tomography and using the reconstruction algorithms known to the skilled person from this imaging process. As will be described in more detail in the following, the influence of the attenuation of the radiation exciting the volume or the object and of the radiation scattered in the volume or in the object can moreover be taken into account in this respect by an iterative process so that a precise image of the observed object can be generated.

As already described, it is in this connection of no consequence for the image generation whether the scattered radiation is generated by X-ray radiation in the object or by internal gamma ray radiation from the observed object.

The arrangement in accordance with the invention and the method in accordance with the invention have a series of advantages over the methods known from the prior art:
A greater intensity gain, which results in a pronounced shortening of the required measurement time, results due to a dispensing with the collimation on the radiation inlet side and/or by the collimation of the exciting radiation.
A further pronounced shortening of the measurement time results from the simultaneous use of a plurality of individual detection units comprising individual detectors and associated collimator diaphragms, with the individual detection units preferably being arranged on a circular arrangement to the side of and around the object to be imaged.
Reconstruction methods known from computer tomography can be used to reconstruct the scatter center by means of tomographic methods. Comparatively high-quality images of the objects can be generated in a simple and fast manner by the possibility of the iterative refinement of the results by step-wise correction of the intensities of the exciting radiation and of the emitted scattering radiation due to the attenuation in the imaged object.
The described structure and the described method can be used universally both for X-ray excited scattered radiation and for the detection of the distribution of gamma radiation.

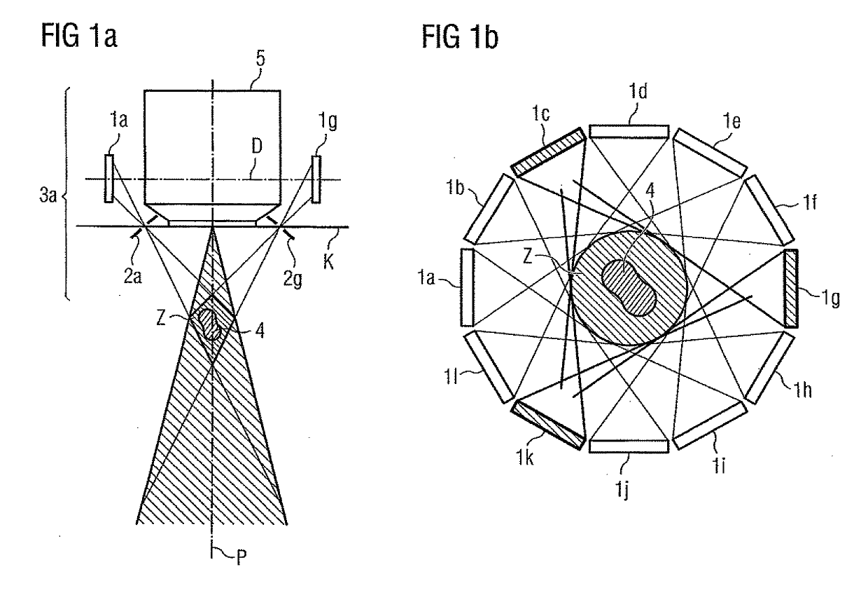

The arrangement in accordance with the invention and the method in accordance with the invention will be described with reference to an embodiment in the following. For this purpose, FIG. 1 shows in FIG. 1a) a side view (section perpendicular through the detector plane or the collimator plane of the arrangement) and FIG. 1b) shows a plan view of the detector plane or collimator plane of the arrangement in accordance with the invention.

FIG. 1a) shows the arrangement in accordance with the invention in which a plurality of individual detectors (12 individual detectors here) are arranged on a circle. The plane formed by the circular arrangement will also be called a detector plane D in the following. The individual detectors are provided with the reference symbols 1a, 1b, . . . ; in the case presented, they are digital flat-screen detectors such as are well known to the skilled person. The individual detectors are aligned in this connection such that their radiation-sensitive surfaces are perpendicular to the detector plane D formed by the circle arrangement.

In accordance with the invention, precisely one collimator 2a, 2b, . . . is now associated in the form of a lead diaphragm (pinhole diaphragm) provided with a hole with every single one of the individual detectors 1a, 1b . . . . The individual collimator diaphragms 2a, 2b, . . . are likewise arranged on a circle; the plane formed by this circle arrangement will also be called a collimator plane K in the following. In the present case, the collimator plane K is arranged parallel to and spaced apart from the detector plane D.

The collimator diaphragms associated one-to-one with the individual detectors are positioned in space in the collimator plane K with respect to their location and their alignment such that all the detection units 3a, 3b, . . . are aligned to a common volume or to a common center Z. A detection unit is in this respect in each case formed by an individual detector together with the collimator diaphragm associated with it (the individual detector 1a, for example, forms the detection unit 3a together with the collimator diaphragm 2a associated with it, and so on. In this respect, aligned to a common center Z means that radiation which starts from this center Z and which passes through the hole of a collimator diaphragm 2 is respectively imaged on the associated detector 1. The center is thus imaged onto the detectors 1a to 1l by a total of 12 “pinhole cameras” 2a to 2l using the known pinhole camera principle. As can be seen from FIG. 1a in this connection, the center Z at which the radiated object 4 to be imaged is arranged is arranged in this respect on the side of the collimator plane K disposed opposite the detection plane D, i.e. the collimator plane K follows first and, spaced further apart from it, the detector plane D, viewed from the center Z. The arrangement shown has the advantage that—as shown—with an arrangement of the irradiating X-ray tube on the side of the collimator plane K on which the detector plane D is also arranged (the tube 5 is arranged here between the detectors 1 or at their center), the object can be both irradiated (through the tube 5) and scanned (by the collimators 2 and the detectors 1) from one side. It is hereby possible also to take large objects such as aircraft wings with the arrangement in accordance with the invention.

As can be seen from FIG. 1a), the diameter of the circle on which the collimator diaphragms 2 are arrangement is smaller than the diameter of the circle on which the detectors 1 are arranged. If the arrangement of the detectors perpendicular to the detector pane D were projected onto the collimator plane K (parallel projection), the center of the detector arrangement and the center of the collimator arrangement would coincide. If one were likewise to project the center Z or the object 4 in the direction perpendicular to the collimator plane K onto this collimator plane, this center Z would come to lie at the center of the projected circles of the detectors and of the collimators. The center Z (or the object 4), the center of the collimator arrangement and the center of the detector arrangement are thus disposed along a common axis P (perpendicular to the planes K and D) and spaced apart from one another.

A further part of the arrangement in accordance with the invention, a computer unit (for example in the form of a personal computer) which is connected after each of the detectors 1a to 1l for signal processing, is not shown here. The individual projection images taken by the respective detectors can therefore be treated in an analog manner to the individual projection images of an X-ray computer tomographic arrangement, i.e. be reverse calculated to layer images of the object in the image processing unit or computer unit connected after the detectors with the help of layer image reconstructive algorithms (such as are known to the skilled person). Each image taken by a detector thus corresponds to a conventional projection; it is necessary in this connection to accumulate the scattered radiation over a specific time (for example some seconds) to obtain a sufficient signal-to-noise ratio. In reality, preferably between 20 and 40 individual detectors are arranged on the circle in the detector plane D (only 12 individual detectors are shown here).

It would also theoretically be possible to arrange the X-ray tube 5 on the side of the object 4 or of the center Z disposed opposite the detector plane D and the collimator plane K; corresponding images can also be reconstructed with such an arrangement. However, this has the disadvantage that the object 4 or the center Z cannot be scanned from a single side.

As already indicated above, it is possible to carry out an iterative reconstruction of the scattering volume 4 in the described computer unit. This is done in that a first, coarse reconstruction is carried out of the object 4 in a first pass by means of the described reconstructive algorithms from the individual projection images of the individual detection units. This first reconstruction delivers a first estimate of the geometry generating the radiation. This first estimate can now be used to take the attenuation of the radiation by this geometry into account and thus to refine this estimate and finally to obtain an image of the object to be inspected which is as exact as possible.

1. Arrangement for the taking of X-ray scatter images and/or gamma ray scatter images, comprising
a plurality of X-ray sensitive and/or gamma ray sensitive individual detectors (1a, 1b, . . . ); and
the same plurality of collimator diaphragms (2a, 2b, . . . ) made for the collimation of X-ray radiation or gamma radiation,
wherein a respective one of the collimator diaphragms is associated with each individual detector, with each of the detection units (3a, 3b, . . . ) formed in this manner from an individual detector and the collimator diaphragm associated with it being arranged such that all the detection units are aligned to one and the same common center (Z).

2. An arrangement according to claim 1,
characterized in that
all the individual detectors are substantially arranged in one plane (detector plane);
and/or
in that all the individual detectors are arranged such that a plane extending trough the common center exists in which, when parallel-projecting the location of the individual detectors to this plane, the projected individual detectors are arranged in this plane around the common center;
and/or
in that all the individual detectors are substantially arranged on a circle.

3. An arrangement according to claim 1,
characterized in that
all the collimator diaphragms are substantially arranged in one plane (collimator plane);
and/or
in that all the collimator diaphragms are arranged such that a plane extending trough the common center exists in which, when parallel-projecting the location of the collimator diaphragms to this plane, the projected collimator diaphragms are arranged in this plane around the common center;
and/or
in that all the collimator diaphragms are substantially arranged on a circle.

4. An arrangement according to claim 1,
characterized in that
the detector plane and the collimator plane are arranged spaced apart from and/or parallel to one another.

5. An arrangement in accordance with claim 2,
characterized in that
the common center is arranged spaced apart from the detector plane and from the collimator plane.

6. An arrangement according to claim 1,
characterized in that
precisely one collimator diaphragm is associated with each individual detector.

7. An arrangement according to claim 1,
characterized by
an X-ray tube (5), in particular an X-ray tube collimated to a small degree or not collimated.

8. An arrangement according to claim 7,
characterized in that
the X-ray tube (5), on the one hand, and all the individual detectors, on the other hand, are arranged spaced apart from the common center (Z) on one and the same side;
or
in that the X-ray tube, on the one hand, and the individual detectors, on the other hand, are arranged on oppositely disposed sides of the common center (Z).

9. An arrangement according to claim 1,
characterized in that
at least one of the collimator diaphragms includes or consists of a pinhole diaphragm.

10. An arrangement according to claim 1,
characterized in that
at least one of the individual detectors is an area detector, in particular a digital flat-screen detector.

11. An arrangement according to claim 10,
characterized in that
at least one of the area detectors is arranged with its X-ray sensitive and/or gamma ray sensitive area perpendicular to the detector plane, and
wherein all the individual detectors are substantially arranged in one plane (detector plane),
and/or
in that all the individual detectors are arranged such that a plane extending trough the common center exists in which, when parallel-projecting the location of the individual detectors to this plane, the projected individual detectors are arranged in this plane around the common center,
and/or
in that all the individual detectors are substantially arranged on a circle.

12. An arrangement according to claim 1,
characterized by
a computer unit, in particular a personal computer (PC), connected after the individual detectors for signal processing and/or for the sectional image reconstruction from projection shots of the individual detectors.

13. An arrangement according to claim 1,
characterized by
at least 10 and at most 50 arranged individual detectors, preferably between 20 and 40 individual detectors.

14. An arrangement according to claim 1,
characterized in that
the arrangement is made transportable and/or in that the arrangement is made movable, is in particular installed on a chassis or on a motorized vehicle.

15. A method for the taking of X-ray scatter images and/or gamma ray scatter images,
wherein the same plurality (2a, 2b, . . . ) of collimator diaphragms made for the collimation of X-ray radiation and/or gamma ray radiation are associated with a plurality of X-ray sensitive and/or gamma ray sensitive individual detectors (1a, 1b, . . . ) such that a respective one of the collimator diaphragms is associated with each individual detector;
wherein each of the detection units (3a, 3b, . . . ) formed from an individual detector and the collimator diaphragm associated with it is disposed such that all the detection units are aligned to one and the same common center (Z);
wherein an object (4) to be imaged is arranged at this common center (Z) and is irradiated by means of X-ray radiation and/or is exposed by means of gamma radiation for the imaging of the object onto the individual detectors; and
wherein an image of the object (4) is prepared from the image data detected by the individual detectors by means of a reconstructive method.

16. A method according to claim 15,
characterized in that
reconstruction takes place iteratively.

17. Use of an arrangement according to claim 1, for quality assurance and/or material inspection on an object (4), in particular for the surface characterization of the object and/or for the location of structural defects of the object such as inclusions or cracks.
